(19) United States
(12) Patent Application Publication
(10) Pub. No.: US 2010/0179239 A1
(43) Pub. Date: Jul. 15, 2010

(54) METHOD OF MINIMIZING COMPRESSION SET OF FOAM

(75) Inventor: Jean-Jacques Katz, Novi, MI (US)

Correspondence Address: QUINN LAW GROUP, PLLC, 39555 ORCHARD HILL PLACE, SUITE # 520, NOVI, MI, 48375, US

(73) Assignee: Automotive Interior Consulting, Novi, MI (US)

(21) Appl. No.: 12/505,844

(22) Filed: Jul. 20, 2009

Related U.S. Application Data
(60) Provisional application No. 61/144,572, filed on Jan. 14, 2009.

(51) Int. Cl. C08G 18/32; B29C 71/02; B29C 35/12

(52) U.S. Cl. 521/170; 264/234; 264/403

(57) ABSTRACT

A method of minimizing compression set of foam includes introducing a composition including a first component and a second component that is reactive with the first component into a cavity of a mold, curing the composition to form a foam inside the cavity, demolding the foam, and heating the foam by induction after demolding to thereby minimize compression set of the foam. A method includes introducing the composition into the cavity, heating the mold via conduction of the mold to thereby cure the composition and form the foam inside the cavity, heating the foam by induction before demolding to thereby minimize compression set of the foam, and demolding the foam. The foam includes a reaction product of the first and second components. The foam has a compression set after heat aging of ≦10% at 10 minutes after the foam is demolded from the cavity of the mold.

### CROSS-REFERENCE TO RELATED APPLICATIONS

This application claims the benefit of U.S. Provisional Application 61/144,572, filed on Jan. 14, 2009, which is hereby incorporated by reference in its entirety.

### TECHNICAL FIELD

The present invention generally relates to foam, and more specifically, to a method of minimizing compression set of foam.

### BACKGROUND OF THE INVENTION

Foams may provide comfort, support, insulation, and structure for many applications requiring a wide range of physical properties in the furniture, automotive, and construction industries. Foams are generally a product of one or more liquid components, and are often formulated according to desired physical properties, such as compression set, core density, resiliency, strength, and firmness.

In particular, foam may be formed during an exothermic foam-forming reaction of components in a preheated mold. During the exothermic foam-forming reaction, foam that is in direct contact with the preheated mold cures to form a foam surface, i.e., a foam skin, whereas foam that is located in a center of the preheated mold cures to form a foam core. Because of the cellular structure of the foam core, the foam core often acts as an insulator that holds heat from the exothermic foam-forming reaction within the foam core. As such, a significant temperature gradient often exists between the foam core and the foam skin.

High temperatures generated within the foam core may positively affect development of physical properties such as compression set, tensile properties, and firmness of the foam, but do not substantially contribute to cure of the foam skin that is in contact with the preheated mold immediately following the foam-forming reaction. Problematically, the slow foam cure rate of the foam skin often prevents foam manufacturers from immediately shipping the foam, especially when less than fully-cured foam is tightly packaged for shipment. Such foam often deforms, displays unwanted indentations, and will not recover an original shape. That is, such foam often suffers from high compression set which generally indicates poor foam cure, and more specifically, poor foam surface cure.

One existing method of minimizing compression set of foam involves aging the foam for from 45 minutes to a few days at room temperature before shipment. However, such foam aging increases processing time, work-in-process inventory storage requirements, and production costs for foam manufacturers. Further, foam aging is often inefficient and can produce varying and erratic physical properties.

For some foam types, another existing method of minimizing compression set may include heating the foam by conduction, such as in an oven, for from 3 to 60 minutes at a temperature of from about 40 to 90° C. after foam formation to post-cure the foam. However, foams post-cured via conduction heating often lack uniformity of physical properties and consistent firmness, and may also exhibit poor compression set. Foams post-cured via conduction heating are therefore typically not optimal for applications requiring support, cushioning, insulation, and/or structural content. Further, post-curing foam via conduction heating increases production costs from increased energy expenditure and contributes to longer manufacturing times.

Depending upon a formulation of the foam, an alternative method of minimizing compression set may include a chemical post-cure, e.g., exposing the foam to a mixture of water vapor, gaseous ammonia, and primary or secondary amines at a temperature of from about 10 to 66° C. for at least one minute immediately after foam formation. However, such chemical post-cure also requires storage of the foam prior to chemical post-cure and involves handling of corrosive amine-based chemicals in the vapor phase.

Moreover, for some foams, compression set may be minimized by altering the foam-forming reaction, e.g., by employing alternate catalysts, blowing agents, and/or surfactants according to reactivity or selectivity. However, such alteration of the foam-forming reaction typically requires significant reformulation and testing, with accompanying costs, and may not produce foams suitable for every industry or application.

### SUMMARY OF THE INVENTION

A method of minimizing compression set of foam includes introducing a composition including a first component and a second component that is reactive with the first component into a cavity of a mold. The composition is cured to form a foam inside the cavity of the mold. The method further includes demolding the foam from the cavity of the mold, and heating the foam by induction after demolding the foam to thereby minimize compression set of the foam.

In another embodiment, a method of minimizing compression set of foam includes introducing the composition into the cavity of the mold, heating the mold via conduction of the mold to thereby cure the composition and form the foam inside the cavity of the mold, heating the foam by induction before demolding the foam to thereby minimize compression set of the foam, and demolding the foam from the cavity of the mold.

A foam includes a reaction product of the first component and the second component. The foam has a compression set after heat aging of less than or equal to 10% at 10 minutes after the foam is demolded from the cavity of the mold.

The methods of the present invention minimize compression set of foam. The methods are efficient and reproducible, and may be completed within ten minutes of demolding. Therefore, the methods minimize costly foam inventory and storage before shipment. Further, the methods do not require alteration of existing foam compositions or handling of corrosive amine-based chemicals in the vapor phase, and are cost-effective for foam manufacturers.

The foam of the present invention exhibits excellent compression set after heat aging, compression set after humid aging, core density, support factor, and humid aged compression force deflection at 10 minutes after demolding.

The above features and advantages and other features and advantages of the present invention are readily apparent from the following detailed description of the best modes for carrying out the invention.

### DESCRIPTION OF THE PREFERRED EMBODIMENTS

A foam and methods of minimizing compression set of foam are described herein. The foam and methods of the present invention are typically useful for automotive seating applications, such as a seat cushion or seat back. However, it is to be appreciated that the foam and methods of the present invention may also be useful for other non-seating automotive applications, such as, but not limited to, head restraints, armrests, dash insulators, jounce bumpers, spring aids, and carpets, as well as for non-automotive applications, such as, but not limited to, furniture and construction applications including tires, shock mounts, and coil spring isolators.

The foam includes a reaction product of a first component and a second component. The foam is a cellular product and therefore stands in contrast to materials such as polypropylene, polyethylene, polyamides, epoxies, polyesters, and rubbers. Suitable foams may be selected from the group of polyurethane foams, latex foams, polyethylene foams, polypropylene foams, polystyrene foams, polyvinylchloride foams, polymethacrylamide foams, rubber foams, polyimide foams, and combinations thereof.

In one embodiment, the foam is polyurethane foam. More specifically, the foam may be a flexible polyurethane foam. As used herein, the terminology flexible polyurethane foam denotes a class of polyurethane foam and stands in contrast to rigid polyurethane foam. Generally, as known in the art, polyurethane foams may be classified as flexible polyurethane foams, having a tensile stress at 10% compression, i.e., compressive strength according to test method DIN 53421, of less than about 15 KPa; semi-rigid polyurethane foams, having a tensile stress at 10% compression of from about 15 to 80 KPa; and rigid polyurethane foams, having a tensile stress at 10% compression of greater than 80 KPa. Although both flexible polyurethane foams and rigid polyurethane foams are formed via a reaction of a polyol and an isocyanate, the terminology flexible polyurethane foam generally describes foam having less stiffness than rigid polyurethane foam. In particular, flexible polyurethane foam is a flexible cellular product, i.e., a cellular, organic, polymeric material that will not rupture when a specimen 200 mm×25 mm×25 mm is bent around a 25 mm diameter mandrel at a uniform rate of 1 lap in 5 seconds at a temperature of from 18 to 29° C., as defined by ASTM D3574-03.

Further, as known in the art, polyol selection impacts the stiffness of polyurethane foams. That is, flexible polyurethane foams are generally produced from polyols having weight average molecular weights of from 1,000 to 10,000 g/mol and hydroxyl numbers of from 18 to 115 mg KOH/g. In contrast, rigid polyurethane foams are generally produced from polyols having weight average molecular weights of from 250 to 700 g/mol and hydroxyl numbers of from 300 to 700 mg KOH/g. Moreover, flexible polyurethane foams generally include more urethane linkages as compared to rigid polyurethane foams, whereas rigid polyurethane foams may include more isocyanurate linkages as compared to flexible polyurethane foams. Further, flexible polyurethane foams are generally produced from polyols having low-functionality (f) initiators, i.e., f<4, such as dipropylene glycol (f=2) or glycerine (f=3). By comparison, rigid polyurethane foams are generally produced from polyols having high-functionality initiators, i.e., f≧4, such as Mannich bases (f=4), toluenediamine (f=4), sorbitol (f=6), or sucrose (f=8). Additionally, as known in the art, flexible polyurethane foams are generally produced from glycerine-based polyether polyols, whereas rigid polyurethane foams are generally produced from polyfunctional polyols that create a three-dimensional cross-linked cellular structure, thereby increasing the stiffness of the rigid polyurethane foam.

Finally, although both flexible polyurethane foams and rigid polyurethane foams include cellular structures, flexible polyurethane foams generally include more open cell walls, i.e., voids, which allow air to pass through the flexible polyurethane foam when force is applied as compared to rigid polyurethane foams. As such, flexible polyurethane foams generally eventually recover shape after compression. In contrast, rigid polyurethane foams generally include more closed cell walls, which restrict air flow through the rigid polyurethane foam when force is applied. Therefore, flexible polyurethane foams are often useful for cushioning and support applications, e.g., seating comfort and support articles, whereas rigid polyurethane foams are often useful for applications requiring thermal insulation, e.g., appliances and building panels.

In another embodiment, the foam may be microcellular polyurethane foam. As used herein, the terminology “microcellular polyurethane foam” refers to foams having densities of less than or equal to about 750 kg/m³. The microcellular polyurethane foams stand in contrast to conventional cellular flexible polyurethane foams which have a coarse cell structure that is visible by inspection with the unaided eye. In contrast, microcellular polyurethane foams have exceptionally small cells with an average cell size of below about 200 μm, and generally below 100 μm. The microcellularity is often observable only as an added “texture” to the microcellular polyurethane foam unless viewed microscopically. As compared to microcellular foams, conventional polyurethane foams have comparatively larger cell size.

For the foam, the first component may be reacted with the second component during a foam-forming reaction. In one embodiment, the first component may be an isocyanate component. For example, in the embodiment including the flexible polyurethane foam, the first component may be a diisocyanate component or a polyisocyanate component. As used herein, the terminology polyisocycanate is to be construed as including prepolymers and free polyisocyanates. The isocyanate component generally provides reactive groups, i.e., NCO groups, during the foam-forming reaction.

The isocyanate component may be selected from the group of toluene diisocyanate (TDI), methylene diphenyl diisocyanate (MDI), including dimers, trimers, and higher oligomers thereof, naphthalene diisocyanate (NDI), 3,3′-dimethyl-4,4′-biphenylene diisocyanate (TODI), and combinations thereof. Suitable isocyanate components may also include, but are not limited to, aliphatic isocyanates such as hexamethylene-diisocyanate-1,6 (HDI), isophorone diisocyanate (IPDI), 4,4′-dicyclohexylmethane-diisocyanate, 1-isocyanato-3,3,5-trimethyl-5-isocyanatomethylcyclohexane, m-tetramethylxylene diisocyanate, tetramethylene-1,4-diisocyanate, 1-methyl-2,4- and 1-methyl-2,6-diisocyanatocyclohexane and mixtures thereof, p-xylylene diisocyanate and m-xylylene diisocyanate (XDI) and mixtures thereof, 2,2,4- and 2,4,4-trimethylhexamethylene diisocyanate, any other aliphatic polyisocyanates which are conventionally employed in the polyurethane art, and combinations of the group. In an embodiment including a combination of TDI and MDI, the TDI may be present in the isocyanate component in an amount of from 65 to 80 parts by weight based on 100 parts by weight of the isocyanate component. Further, the isocyanate component may have NCO groups in an amount of from 5 to 50 parts by weight based on 100 parts by weight of the isocyanate component.

The second component may be reactive with the first component. For example, the first component may be reacted with the second component in a ratio of from 0.5 to 1.5 parts by weight of the first component to parts by weight of the second component. For embodiments including the isocyanate component as the first component, the first component and the second component may be reacted at an isocyanate index of from 50 to 150. The terminology isocyanate index refers to a ratio of isocyanate groups to hydroxyl groups present in polyurethane compounds. Additionally, the first component and the second component may be combined in any order. That is, the first component may be added to the second component or the second component may be added to the first component.

In the embodiment including the flexible polyurethane foam, the second component may be an isocyanate-reactive component. The isocyanate-reactive component generally provides hydroxyl groups for reaction with the NCO groups of the isocyanate component. More specifically, the second component may include a polyol. The second component may also include at least two polyols. Any known polyol suitable for reaction with the isocyanate component is suitable for purposes of the present invention. For example, the isocyanate-reactive component may be selected from the group of polyether polyols, polyoxyalkylene polyols, polyester polyols, graft polyols, polymer polyols, polyols derived from renewable resources, such as, but not limited to, soy polyols, castor oil polyols, and combinations thereof. Examples of suitable polymer polyols include, but are not limited to, polyol dispersions of acrylonitrile/styrene particles and polymer-modified polyols such as polyisocyanate polyaddition (PIPA) polyols and poly Hamstoff dispersion (PHD) polyols.

The second component may also include a crosslinker. The crosslinker generally allows phase separation between copolymer segments of the polyurethane foam. That is, the polyurethane foam generally includes both rigid urea copolymer segments and soft polyol copolymer segments. The crosslinker preferably chemically and physically links the rigid urea copolymer segments to the soft polyol copolymer segments. Therefore, the crosslinker is generally present in the second component to modify the hardness and reduce shrinkage of the polyurethane foam. Suitable crosslinkers include any crosslinker known in the art such as, for example, diethanolamine in water.

The second component may also include a catalyst component. The catalyst component is generally present in the second component to catalyze the foam-forming reaction between the first component and the second component. The catalyst component is typically not consumed to form the foam. That is, the catalyst component preferably participates in, but is not consumed by the foam-forming reaction. The catalyst component may include any suitable catalyst or combinations of catalysts known in the art. Examples of suitable catalysts include, but are not limited to, gelation catalysts, blowing catalysts, and tin catalysts.

The second component may further include an additive component. The additive component may be selected from the group of surfactants, blowing agents, blocking agents, dyes, pigments, diluents, solvents, specialized functional additives such as antioxidants, ultraviolet stabilizers, biocides, adhesion promoters, antistatic agents, mold release agents, fragrances, flame retardants, and combinations of the group. Suitable additive components may include any known blocking agent, dye, pigment, diluents, solvent, and specialized functional additive known in the art.

A surfactant may be present in the additive component of the second component to control cellular structure of the foam and to improve miscibility of components and foam stability. A blowing agent may be present in the additive component of the second component to facilitate the formation of the foam. That is, as known in the art, during the foam-forming reaction between the first component and the second component, the blowing agent generally promotes the release of a blowing gas which facilitates the formation of cellular structure in the foam. The blowing agent may be a physical blowing agent or a chemical blowing agent.

The terminology physical blowing agent refers to blowing agents that do not chemically react with the isocyanate component and/or the isocyanate-reactive component to provide the blowing gas. The physical blowing agent can be a gas or liquid. The liquid physical blowing agent generally evaporates into a gas when heated, and preferably returns to a liquid when cooled. The physical blowing agent may reduce the thermal conductivity of the foam. Liquid carbon dioxide is a suitable example of a physical blowing agent.

The terminology chemical blowing agent refers to blowing agents which chemically react with the isocyanate component or with other components to release a gas that promotes foam formation. Water is a suitable example of a chemical blowing agent.

The foam has a compression set after heat aging of less than or equal to 10% at 10 minutes after the foam is demolded from a cavity of a mold, as measured in accordance with ASTM D3574-08. To measure the compression set after heat aging of the foam, a specimen of the foam having dimensions of 50 mm×50 mm×25 mm is compressed at 10 minutes after demolding to 50% of an original thickness of the foam for 22 hours between two parallel plates. The specimen of foam is then placed in a mechanical convection oven at a temperature of about 70° C. +/−2° C. for 22 hours. A thickness of the specimen of foam is measured before and after the foam is compressed and a percent loss, i.e., a percentage of original thickness, is calculated for the foam. The percent loss is the compression set.

Another method for determining whether the foam has a compression set after heat aging of less than or equal to 10% at 10 minutes after demolding is a visual inspection of the foam after forming. More specifically, within 10 minutes of demolding, the surface of the specimen of foam is indented by about 5 mm within a surface area of 25 mm×25 mm to form an indentation. A recovery of the indentation is monitored. A complete recovery of the indentation within 10 seconds may indicate a compression set after heat aging of less than or equal to 10%.

Moreover, the foam may have a compression set after humid aging of from 10 to 35% at 10 minutes, for example 6 minutes, after demolding as measured in accordance with ASTM D3574-08, Test D, L. Additionally, the foam may have a core density of from 24 to 96 kg/m³ at 10 minutes after demolding as measured in accordance with ASTM D1622-98. Further, the foam may have a support factor of from 2.0 to 4.0 at 10 minutes after demolding as measured in accordance with ASTM D3574-08, Test B₁. The support factor may also be referred to as sag factor, hardness ratio, or comfort factor, and is defined as a ratio of indentation force deflection (IFD) at 65% deflection to IFD at 25% deflection. Also, the foam may have a compression force deflection (CFD) at 50% deflection after heat aging of from 5 to 40%, after demolding as measured in accordance with ASTM D3574-08, Test C, L. More specifically, the foam may have a CFD at 50% deflection after heat again of from 7.5 to 30% at 10 minutes after demolding.

The foam may also include a conductor. The conductor may be any known metal in the art suitable for conducting electrical current. For example, the conductor may be a ferrous magnet or may be a metal insert, such as a frame, wire, strip, or flexilator, formed from, for example, steel.

Additionally, the foam may include plastic elements. For example, the foam may include plastic knobs, supports, or frames. The plastic elements may be formed from a plastic selected from the group of high density polyethylene (HDPE), polyvinylchloride (PVC), polypropylene (PP), acrylonitrile butadiene styrene terpolymer (ABS), polycarbonate (PC), polyamide (PA), nylon, polyethyleneterephthalate (PET), polybutyleneterephthalate (PBT), and combinations thereof.

In one example, the foam is an automotive seat cushion. In this embodiment, when the first component includes TDI or a combination of TDI and MDI, the core density of the foam may be from 30 to 64 kg/m³, for example, 30 to 40 kg/m³. In contrast, in this embodiment, when the first component does not include TDI, the core density of the foam may be from 32 to 64 kg/m³, for example, from 40 to 45 kg/m³.

In another example, the foam is an automotive seat back. In this embodiment, when the first component includes TDI or a combination of TDI and MDI, the core density of the foam may be from 22 to 45 kg/m³, for example, 26 to 35 kg/m³. In contrast, in this embodiment, when the first component does not include TDI, the core density of the foam may be from 32 to 48 kg/m³, for example, from 40 to 45 kg/m³.

In another example, the foam is an automotive trim, such as a head restraint or an armrest. In this embodiment, when the first component includes TDI, MDI, or combinations thereof, the core density of the foam may be from 32 to 96 kg/m³, for example, from 40 to 64 kg/m³.

In yet another example, the foam is an automotive insert configured for optimizing acoustics within an interior of an automobile. In this embodiment, the foam generally includes MDI, and may have a core density of from 32 to 64 kg/m³.

In a further example, the foam is a furniture cushion. In this embodiment, when the first component includes TDI, MDI, or combinations thereof, the core density of the foam may be from 32 to 96 kg/m³, for example, from 40 to 56 kg/m³.

In another example, the foam is a furniture back. In this embodiment, when the first component includes TDI or a combination of TDI and MDI, the core density of the foam may be from 22 to 45 kg/m³, for example, from 26 to 35 kg/m³. In contrast, in this embodiment, when the first component does not include TDI, the core density of the foam may be from 32 to 48 kg/m³, for example, from 40 to 45 kg/m³.

In another example, the foam is a furniture trim, such as a head restraint or an armrest. In this example, when the first component includes TDI, MDI, or combinations thereof, the core density of the foam may be from 32 to 96 kg/m³, for example, from 40 to 64 kg/m³.

The foam of the present invention exhibits excellent compression set after heat aging, compression set after humid aging, core density, support factor, and humid aged compression force deflection at 10 minutes after demolding, as set forth in more detail below.

A method of minimizing compression set of foam includes introducing a composition including the first component and the second component into a cavity of a mold. The mold and cavity may be of any shape, and may include complex or irregular shapes. For example, the mold may be shaped to produce an automotive seat cushion. Additionally, the mold may be unitary, e.g., formed in one member, or may include one or more halves configured for attaching to form the mold.

Upon introduction of the composition to the cavity, the mold may encapsulate the composition so that the composition is disposed within the cavity of the mold. The composition may be introduced into the cavity of the mold via any suitable device or process known in the art for introducing the composition into the cavity of the mold. For example, the composition may be poured, injected, deposited, coated, sprayed, or otherwise placed into the cavity of the mold. In one example, the composition may be injected into the cavity of the mold after the first component and the second component are mechanically mixed at a temperature of from 15 to 45° C. and a pressure of from 6 to 21 MPa. The first component and the second component of the composition may be transported under pressure through separate lines to a pourhead before being introduced into the cavity of the mold. Alternatively, the first component and the second component may be concurrently combined and introduced into the cavity of the mold to form the composition in the cavity of the mold. The cavity of the mold may also be vented with at least one vent to allow for foam off-gassing. Further, in one embodiment, the mold may be heated. For example, the mold may be exposed to an external heat source, such as a conduction oven. Alternatively, the mold may include heated fluid circulation within the cavity of the mold.

The method also includes curing the composition to form the foam inside the cavity of the mold. The composition may be cured over a residence time of from 2 to 20 minutes, for example, from 2 to 12 minutes. In the embodiment including polyurethane foam, curing the composition generally changes the composition from a mobile liquid to a rubbery product. More specifically, as the composition expands into the cavity, the viscosity of the composition increases, and an exotherm having a temperature of from 66 to 180° C. is generally generated by the foam-forming reaction. The exotherm generally cures an interior of the foam, e.g., a core of the foam. The foam may be cured, for example, by heating the mold by conduction, as set forth in more detail below.

The method also includes demolding the foam from the cavity of the mold. Demolding the foam may be further defined as separating the foam from the cavity of the mold. The foam may be demolded via any known demolding method in the art. For example, the foam may be manually removed from the cavity of the mold. Alternatively, the foam may be automatically removed from the cavity of the mold. The foam may be demolded with the assistance of one or more mold release agents. Moreover, demolding may include removing the mold from the foam or removing the foam from the mold. It is also to be appreciated that, for embodiments including a pressurized mold, the method may also include depressurizing the mold.

The method further includes heating the foam by induction after demolding the foam to minimize compression set of the foam. That is, for the method, the foam is heated by induction “offline”, i.e., after curing and demolding of the foam. The terminology “heating by induction” refers to heating the foam to induce heat within the foam by exposing the foam to a circulating electrical current and an electromagnetic field. Heating by induction may be accomplished by any apparatus or method for induction heating suitable for inducing heat through the foam to accelerate the cure and minimize compression set of the foam.

In one embodiment, the method may include inserting the aforementioned conductor into the foam after curing and prior to heating by induction. That is, for embodiments where the foam does not include the conductor upon curing, the conductor may be inserted into the foam after curing the composition to form the foam, and prior to heating the foam by induction. The conductor may be shaped in any suitable configuration for insertion into the foam. The conductor may include shapes such as, for example, a foil, sheet, laminate, rod, wire, tube, shell, coil, spring, or box. The conductor may also be removable from the foam.

In another embodiment, the method may include inserting the foam into the conductor after curing and prior to heating by induction. That is, for embodiments where the foam does not include the conductor upon curing, the foam may be inserted into the conductor after curing the composition to form the foam, and prior to heating the foam by induction. In this embodiment, the conductor may be shaped according to the shape of the foam. Or, the conductor may be generally box-shaped, e.g., the conductor may be a cage or a container or a shell, into which the foam may be inserted.

Further, the conductor may be placed adjacent a surface, i.e., a skin, of the foam. Stated differently, in this embodiment, the conductor may surround, but may not contact the foam. For example, the conductor may be disposed proximal to the foam, e.g., as close to the foam as possible, without contacting the surface, i.e., the skin, of the foam. In this embodiment, the shape of the conductor may generally correlate to a shape of the foam.

In another embodiment, the conductor may be placed onto the surface of the foam so as to be disposed in contact with the surface. That is, in this embodiment, the conductor preferably surrounds and contacts the foam. In this embodiment, the shape of the conductor also may generally correlate to the shape of the foam.

In one example of heating by induction, a solid state radio frequency power supply provides an alternating electrical current through an induction coil to produce a magnetic field. The induction coil may be, for example, a copper coil. The induction coil may be configured for ease of insertion and/or removal of the foam into and/or from the induction coil. The induction coil may have one or more turns, and may have, for example, a helical, round, triangular, pancake, or square shape. The induction coil may be configured as an internal induction coil, e.g., for foam disposed within the induction coil, or an external induction coil, e.g., for foam disposed adjacent to, but not surrounded by, the induction coil. Further, the induction coil may be split and hinged for ease of placement around the foam. A diameter of an individual turn of the induction coil may be from 3 to 5 mm. A cross-sectional area of the induction coil is generally selected according to desired temperature of the surface of the foam. For example, a smaller cross-sectional area generally optimizes uniform temperature of the surface of the foam. Additionally, the induction coil may be cooled, for example by circulating water.

During heating by induction, the foam, including or surrounded by the conductor, is disposed within and surrounded by the induction coil. The induction coil may function as a transformer primary, and the foam, including or surrounded by the conductor, may function as a short circuit secondary. As the foam and the conductor are disposed within the induction coil and enter the magnetic field, circulating eddy currents may be induced in the conductor adjacent the foam. The eddy currents generally flow against an electrical resistivity of the conductor, and may generate precise and localized heat without any direct contact between the foam, the conductor, and the induction coil. Additionally, if the conductor includes a magnetic metal, such as steel, the conductor may produce additional heat through hysteresis.

During heating of the foam by induction, the conductor may increase in temperature and transfer heat from the conductor to the foam to accelerate curing of the foam, e.g. increase polymerization of the foam, and minimize compression set. Heating of the foam may accelerate the cure of the surface and/or the core of the foam. Preferably, heating of the foam by induction accelerates the foam surface cure, i.e., post-cure of the surface of the foam. In this embodiment, the foam may be indirectly heated via induction rather than directly heated by conduction after demolding.

In particular, heating by induction may be further defined as exposing the foam to an alternating electrical current having a power rating of from 25 to 300 kW at a frequency of from 5 to 450 kHz for from 0.1 to 60 minutes. For flexible polyurethane foam applications, the foam may be heated by induction for less than or equal to about 20 minutes. In contrast, for microcellular polyurethane foam applications, the foam may be heated by induction for greater than about 20 minutes. Heating by induction generally may induce a temperature of from 100 to 300° C. in the foam. Frequencies of from 100 to 400, and more preferably from 200 to 400 kHz generally accelerate the cure of the surface of the foam, while frequencies of from 5 to 30 kHz generally accelerate the cure of the core of the foam.

Alternatively, the alternating electrical current may be pulsed through the conductor disposed adjacent the foam. That is, heating may be further defined as exposing the foam to a pulsed electrical current having a power rating of from 25 to 300 kW at a frequency of from 5 to 450 kHz for from 0.1 to 60 minutes. It is believed that pulsed alternating electrical current induces changes in the magnetic field and may create heating via a lower current as compared to the electrical current provided by the solid state radio frequency power supply.

Without intending to be limited by theory, the amount of electrical current flow is generally proportional to a distance between the induction coil and the foam. Therefore, disposing the foam and the conductor a relatively small distance from the induction coil increases the flow of electrical current and the amount of heat induced in the foam. In contrast, disposing the foam and the conductor a relatively large distance from the induction coil decreases the flow of electrical current and the amount of heat induced in the foam.

Advantageously, heating the foam by induction avoids soaking times, lengthy foam cooling cycles, and aging foam inventory, and is environmentally sound without flame, smoke, waste heat, noxious emissions, or loud noise. Further, induction heating provides up to 80% energy savings as compared to post-curing the surface of the foam by other heating processes. Finally, heating the foam by induction allows for excellent temperature consistency at the foam skin.

For the method, the foam is heated by induction after demolding the foam to minimize compression set of the foam. More specifically, heating may conclude within 10 minutes after demolding the foam. In particular, heating the foam by induction provides the foam having a compression set of less than or equal to 10% at 10 minutes after demolding, for example, at 6 minutes after demolding.

In yet another embodiment, a method of minimizing compression set of foam includes introducing the composition into the cavity of the mold. As set forth above, the composition includes the first component and the second component that is reactive with the first component.

In this embodiment, the method further includes heating the mold via conduction of the mold to thereby cure the composition and form the foam inside the cavity of the mold. Heating the mold via conduction allows for efficient, controllable, and predictable cure of the foam core, especially for compositions requiring a cure temperature of greater than 66° C. Heating the mold via conduction may be further defined as heating the mold to a temperature of from −1 to 95° C., for example, 48 to 72° C. That is, the mold may be heated to transfer thermal energy from a heat source to the mold. In one specific example, the foam may be molded to produce, for example, cold cure (CC) high resiliency (HR) foam. In this example, the composition is introduced into the mold, and the mold may be heated to a temperature of from 30 to 80° C. Pressure may alternatively or additionally be applied to the mold.

The mold may be heated via any known conduction process. For example, heating the mold via conduction may be further defined as baking the mold in an oven such as a hot air convection oven. In another example, fluid at an elevated temperature may be circulated around the mold, or within the walls of the mold, so as to transfer heat via conduction from the fluid to the mold. Alternatively, the mold may be exposed to radiant or infrared heat so that thermal energy is conducted through the mold.

For the method, the foam is demolded from the cavity of the mold, as set forth above. However, the method includes heating the foam by induction before demolding the foam to thereby minimize compression set of the foam. That is, in this embodiment, the foam is heated by induction “online”, i.e., after the foam is cured, but before the foam is post-cured and demolded. As set forth above, heating by induction may be further defined as exposing the foam to an alternating electrical current having a power rating of from 25 to 300 kW at a frequency of from 5 to 450 kHz for from 0.1 to 60 minutes. Heating the foam by induction may be further defined as post-curing an outer surface, i.e., a skin, of the foam. That is, it is believed that heating the foam by induction allows the outer surface of the foam to substantially complete any unreacted reactions and thereby post-cure. Stated differently, the foam may be heated by induction after heating the mold via conduction concludes. Heating the mold via conduction cures the foam, and heating the foam by induction post-cures the foam, specifically the skin of the foam, to minimize unreacted chemical moieties.

The method including both heating the mold via conduction and heating the foam by induction effectively post-cures the foam. Further, it is not necessary to decommission any conventional foaming equipment of a foam production line, such as conduction ovens and molding devices. That is, for the method including heating the foam by induction after demolding the foam or for the method including heating the foam by induction before demolding the foam, existing foaming production lines must merely be retrofitted with an apparatus to heat the foam via induction. Therefore, the method is especially useful to foam manufacturers who have previously invested in conventional foaming production equipment, but who desire foam having excellent compression set at less than or equal to 10 minutes after the foam is demolded, without the expense of aging the foam.

Further, for the method including both heating the mold via conduction and heating the foam by induction, it is not necessary to reformulate the foam composition, since the foam core is still cured inside the cavity of the mold via conduction of the mold. For example, the methods allow for traditional curing of foams requiring comparatively high cure temperatures, such as greater than 65° C. That is, the methods allow for efficient post-curing of the skin of the foam while also ensuring adequate cure of the foam core.

As set forth above, the methods of the present invention minimize compression set of the foam to allow for immediate shipment and packaging of foam. The methods are efficient and reproducible, and may be completed within ten minutes of demolding. Further, the methods may also be easily integrated into existing foam manufacturing facilities. Additionally, the methods do not require alteration of existing foam compositions or handling of corrosive amine-based chemicals in the vapor phase, and are cost-effective for foam manufacturers.

The following examples are meant to illustrate the invention and are not to be viewed in any way as limiting to the scope of the invention.

### EXAMPLES

### Example 1

A foam is produced from a reaction product of a first component including Isocyanate A and a second component including Polyol B, Catalysts C-D, Surfactant E, and Additives F-H. More specifically, 135 g of the first component and 415 g of the second component are hand-mixed using a hand drill in a cardboard cup at 3,000 rpm and ambient temperature (22-25° C.) for 10 seconds to produce the mixture of Example 1. The mixture of Example 1 is introduced into a 356 mm×356 mm×76 mm aluminum mold having an inside surface temperature of from 50-55° C. and a wall thickness of about 13 mm so that the first component and the second component react and cure over a duration of 4 minutes to form the foam of Example 1. The foam of Example 1 has a density of 40 kg/m³. The specific amounts of each component are listed below in Table

TABLE 1

| Component | Quantity (g) |
|---|---|
| First component | |
| Isocyanate A | 135.22 |
| Index | 139 |
| Second component | |
| Polyol B | 394.24 |
| Catalyst C | 1.58 |
| Catalyst D | 0.43 |
| Surfactant E | 3.15 |
| Additive F | 2.76 |
| Additive G | 2.76 |
| Additive H | 9.86 |
| Total | 414.72 |

Isocyanate A is toluene diisocyanate (TDI) commercially available under the trade name VORANATE™ T-80 from The Dow Chemical Company of Midland, Mich.

Polyol B is a glycerine-initiated, ethylene oxide-capped polyether diol commercially available under the trade name Jeffol® G31-28 from Huntsman, LLC of The Woodlands, Tex.

Catalyst C is an amine-based gelation catalyst in 67% dipropylene glycol commercially available under the trade name DABCO 33-LV® from Air Products and Chemicals, Inc. of Philadelphia, Pa.

Catalyst D is an amine-based catalyst including 70% bis(2-dimethylaminoethyl)ether commercially available under the trade name Niax* Catalyst A-1 from Momentive Performance Materials of Wilton, Conn.

Surfactant E is a silicone surfactant commercially available under the trade name TEGOSTAB® B 8737 LF2 from Evonik Goldschmidt Corp. of Hopewell, Va.

Additive F is 85% diethanolamine in water commercially available under the trade name Diethanolamine 85% LFG from Huntsman, LLC of The Woodlands, Tex.

Additive G is glycerine.

Additive H is water.

The foam of Example 1 is manually demolded from the aluminum mold over a total duration of about 80 seconds. The 356 mm×356 mm×76 mm foam block is cut into three 76 mm×76 mm×76 mm samples over a total duration of about 80 seconds to form the foams of Examples 1A-1C.

After demolding the foam of Example 1A, and in preparation for heating the foam by induction, the foam of Example 1A is again placed into the aluminum mold, and the aluminum mold is placed onto a pancake induction heating coil. The pancake induction heating coil is formed from copper tubing having a diameter of approximately 3 mm One surface of the pancake induction heating coil is covered by a RF-transparent polytetrafluoroethylene thermal insulator sheet having a thickness of about 1.3 mm The pancake induction heating coil is powered by a 60 kW power unit that supplies alternating electrical current at a frequency of 32 kHz. The foam of Example 1A is heated by induction at a temperature of about 177° C. for about 5 minutes.

The aforementioned method is repeated for the foam of Example 1B, with the exception that the foam of Example 1B is heated by induction at a temperature of about 191° C. for about 6 minutes.

And, the aforementioned method is repeated for the foam of Example 1C, with the exception that the foam of Example 1C is heated by induction at a temperature of about 210° C. for about 1 minute. The induction heating parameters for Examples 1A —1C are summarized below in Table 2.

TABLE 2

| Parameter | Example 1A | Example 1B | Example 1C |
|---|---|---|---|
| Mold Material | Aluminum | Aluminum | Aluminum |
| Heating by Induction Occurs | After | After | After |
| | demolding | demolding | demolding |
| Induction Heating Device | Pancake coil | Pancake coil | Pancake Coil |
| Electrical Current Power | 60 kW | 60 kW | 60 kW |
| Electrical Current Frequency | 32 kHz | 32 kHz | 32 kHz |
| Induction Heating Temp. | 177 | 191 | 210 |
| (° C.) | | | |
| Induction Heating Time | 5 | 6 | 1 |
| (min.) | | | |

In accordance with ASTM D3574-08, the foams of Examples 1A-1C are evaluated for compression set after heat aging at 10 minutes after the foam is demolded from the aluminum mold. To measure the compression set after heat aging of the foams of Examples 1A-1C, a specimen of each foam having dimensions of 50 mm×50 mm×25 mm is compressed at 10 minutes after demolding to 50% of an original thickness of the foam for 22 hours between two parallel plates. The specimen is then placed in a mechanical convection oven at a temperature of about 70° C. +/−2° C. for 22 hours. A thickness of the specimen is measured before and after the foam is compressed and a percent loss, i.e., a percentage of original thickness, is calculated for the foam. The percent loss is the compression set.

The foams of Examples 1A-1C are also evaluated for compression set after heat aging at 10 minutes after the foams are demolded from the aluminum mold by visual inspection. More specifically, within 10 minutes of demolding, an outer surface of each foam of Examples 1A-1C is indented by about 5 mm within a surface area of 25 mm×25 mm to form an indentation. A recovery of the indentation is visually monitored to verify a substantially complete recovery of the indentation within 10 seconds.

Each foam of Examples 1A-1C exhibits a percent loss of less than or equal to 10% at 10 minutes after each foam is demolded from the aluminum mold. Further, a recovery of the 5 mm indentation is substantially complete within 10 seconds after demolding each foam from the aluminum mold. Therefore, each foam of Examples 1A-1C has a compression set after heat aging of less than or equal to 10% at 10 minutes after each foam is demolded.

### Example 2

A foam is produced from a reaction product of a first component including Isocyanate A and a second component including Polyol B, Catalysts C-D, Surfactant E, and Additives F-H according to the specific amounts of each component set forth above in Table 1. More specifically, 135 g of the first component and 415 g of the second component are hand-mixed using a hand drill in a cardboard cup at 3,000 rpm and ambient temperature (22-25° C.) for 10 seconds to produce the mixture of Example 2. Equal amounts of the mixture of Example 2 are introduced into three 356 mm×356 mm×76 mm steel molds having an inside surface temperature of from 50-55° C. and a wall thickness of about 13 mm.

Each of the three steel molds are heated by conduction at a temperature of about 60° C. by placing each steel mold into a conduction oven for a duration of 4 minutes so that the first component and the second component react and cure to form the foams of Example 2A, 2B, and 2C, respectively. The foams of Examples 2A-2C each have a density of 40 kg/m³.

In preparation for heating the foams of Examples 2A-2C by induction before demolding the foams, the steel mold containing the foam of Example 2A is placed onto a pancake induction heating coil. The pancake induction heating coil is formed from copper tubing having a diameter of approximately 3 mm One surface of the pancake induction heating coil is covered by a RF-transparent polytetrafluoroethylene thermal insulator sheet having a thickness of about 1.3 mm. The pancake induction heating coil is powered by a 100 kW power unit that supplies alternating electrical current at a frequency of 32 kHz.

The aforementioned method is repeated for the foam of Example 1B, with the exception that the foam of Example 1B is heated by induction at a temperature of about 191° C. for about 6 minutes.

The aforementioned method is also repeated for the foam of Example 1C, with the exception that the foam of Example 1C is heated by induction at a temperature of about 210° C. for about 1 minute. The induction heating parameters for Examples 2A-2C are summarized below in Table 3.

TABLE 3

| Parameter | Example 2A | Example 2B | Example 2C |
|---|---|---|---|
| Mold Material | Steel | Steel | Steel |
| Heating by Induction Occurs | Before | Before | Before |
| | demolding | demolding | demolding |
| Induction Heating Device | Pancake coil | Pancake coil | Pancake Coil |
| Electrical Current Power | 100 kW | 100 kW | 100 kW |
| Electrical Current Frequency | 32 kHz | 32 kHz | 32 kHz |
| Induction Heating Temp. | 177 | 191 | 210 |
| (° C.) | | | |
| Induction Heating Time | 5 | 6 | 1 |
| (min.) | | | |

After the foams of Examples 2A-2C are heated by induction, the foams of Examples 2A-2C are demolded from the steel molds. The foams are evaluated for compression set after heat aging at 10 minutes after the foams are demolded from the steel mold, in accordance with ASTM D3574-08 as set forth above for Examples 1A-1C.

The foams of Examples 2A-2C are also evaluated for compression set after heat aging at 10 minutes after the foams are demolded from the steel mold by visual inspection. More specifically, within 10 minutes of demolding, an outer surface of each foam of Examples 2A-2C is indented by about 5 mm within a surface area of 25 mm×25 mm to form an indentation. A recovery of the indentation is visually monitored to verify a substantially complete recovery of the indentation within 10 seconds.

Each foam of Examples 2A-2C exhibits a percent loss of less than or equal to 10% at 10 minutes after each foam is demolded from the steel mold. Further, a recovery of the 5 mm indentation is substantially complete within 10 seconds after demolding each foam from the steel mold. Therefore, each foam of Examples 2A-2C has a compression set after heat aging of less than or equal to 10% at 10 minutes after each foam is demolded.

While the best modes for carrying out the invention have been described in detail, those familiar with the art to which this invention relates will recognize various alternative designs and embodiments for practicing the invention within the scope of the appended claims.

1. A method of minimizing compression set of foam, the method comprising:
introducing a composition including a first component and a second component that is reactive with the first component into a cavity of a mold;
curing the composition to form a foam inside the cavity of the mold;
demolding the foam from the cavity of the mold; and
heating the foam by induction after demolding the foam to thereby minimize compression set of the foam.

2. The method of claim 1, wherein heating concludes within 10 minutes after demolding.

3. The method of claim 1, wherein heating is further defined as exposing the foam to an alternating electrical current having a power rating of from 25 to 300 kW at a frequency of from 5 to 450 kHz for from 0.1 to 60 minutes.

4. The method of claim 1, further comprising inserting a conductor into the foam after curing and prior to heating.

5. The method of claim 1, further comprising inserting the foam into a conductor after curing and prior to heating.

6. The method of claim 1, wherein demolding is further defined as separating the foam from the cavity of the mold.

7. A method of minimizing compression set of foam, the method comprising:
introducing a composition into a cavity of a mold;
wherein the composition includes a first component and a second component that is reactive with the first component;
heating the mold via conduction of the mold to thereby cure the composition and form a foam inside the cavity of the mold;
demolding the foam from the cavity of the mold; and
heating the foam by induction before demolding the foam to thereby minimize compression set of the foam.

8. The method of claim 7, wherein heating the foam by induction is further defined as post-curing an outer surface of the foam.

9. The method of claim 8, wherein heating the foam by induction is further defined as exposing the foam to an alternating electrical current having a power rating of from 25 to 300 kW at a frequency of from 5 to 450 kHz for from 0.1 to 60 minutes.

10. The method of claim 7, wherein the foam is heated by induction after heating the mold via conduction concludes.

11. The method of claim 7, wherein heating the mold via conduction is further defined as heating the mold to a temperature of from −1 to 95° C.

12. The method of claim 11, wherein heating the mold via conduction is further defined as baking the mold in an oven.

13. A foam comprising a reaction product of:
a first component; and
a second component;
wherein the foam has a compression set after heat aging of less than or equal to 10% at 10 minutes after the foam is demolded from a cavity of a mold.

14. The foam of claim 13, wherein said foam is polyurethane foam.

15. The foam of claim 14, wherein said foam is microcellular polyurethane foam.

16. The foam of claim 13, wherein said first component is an isocyanate component.

17. The foam of claim 16, wherein said isocyanate component is selected from the group of toluene diisocyanate (TDI), methylene diphenyl diisocyanate (MDI), naphthalene diisocyanate (NDI), 3,3′-dimethyl-4,4′-biphenylene diisocyanate (TODI), and combinations thereof.

18. The foam of claim 13, wherein said second component is an isocyanate-reactive component.

19. The foam of claim 18, wherein said isocyanate-reactive component is selected from the group of polyether polyols, polyoxyalkylene polyols, polyester polyols, graft polyols, polymer polyols, polyols derived from renewable resources, and combinations thereof.

20. The foam of claim 13, wherein said first component and said second component are reacted at an isocyanate index of from 50 to 150.
